(19) United States
(12) Patent Application Publication
(10) Pub. No.: US 2005/0022801 A1
(43) Pub. Date: Feb. 3, 2005

(54) Household outdoor gas cooking stove with an enclosure to provide wind shielding during cooking and protect stove and cooking apparatus while not in use

(76) Inventor: Hsinhan Wu, Kenmore, WA (US)

Correspondence Address: HSINHAN WU, 14821 74th PL NE, KENMORE, WA, 98028, US

(21) Appl. No.: 10/630,617

(22) Filed: Jul. 31, 2003

(51) Int. Cl. A47J 37/00

(52) U.S. Cl. 126/25 R

(57) ABSTRACT

A gas stove is placed inside of a barbeque grill like enclosure of any shape with a lid to provide wind shielding during cooking and protect the gas stove and cooking apparatus from wind, rain, snow and other natural element when stove is not in use. The unit will have barbeque grill like frame, shelves, and wheels for maneuverability and areas to accommodate plates and food items. The lower part of the enclosure has holes to provide air intake for the gas stove and drainage.

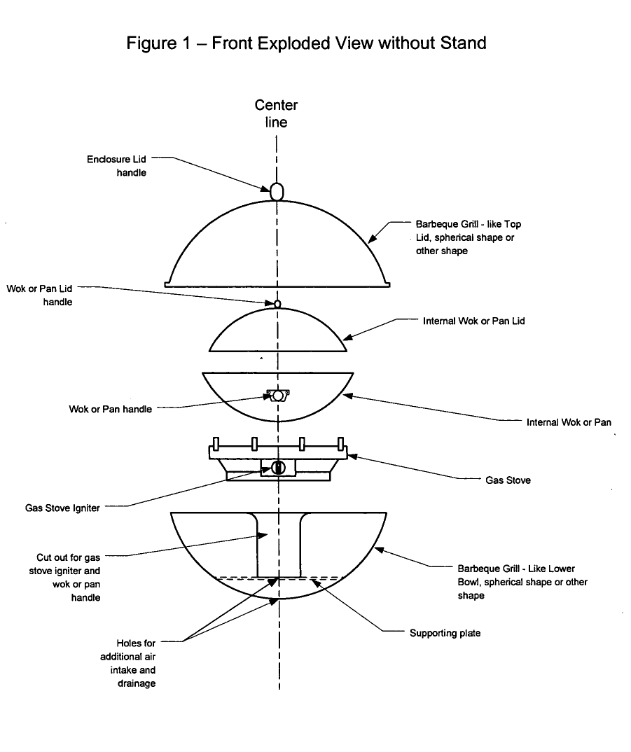

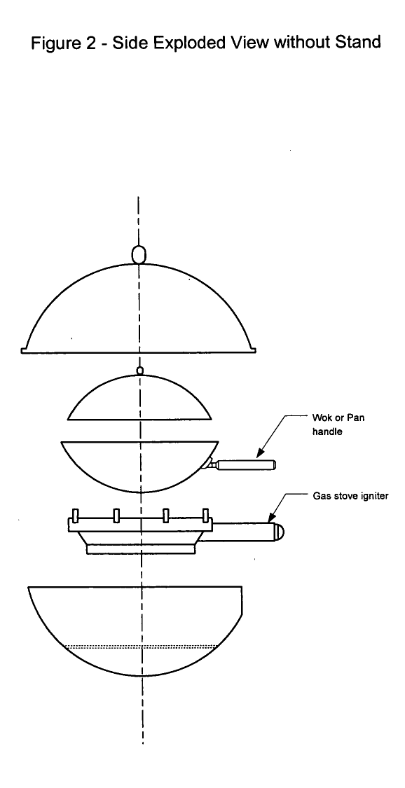

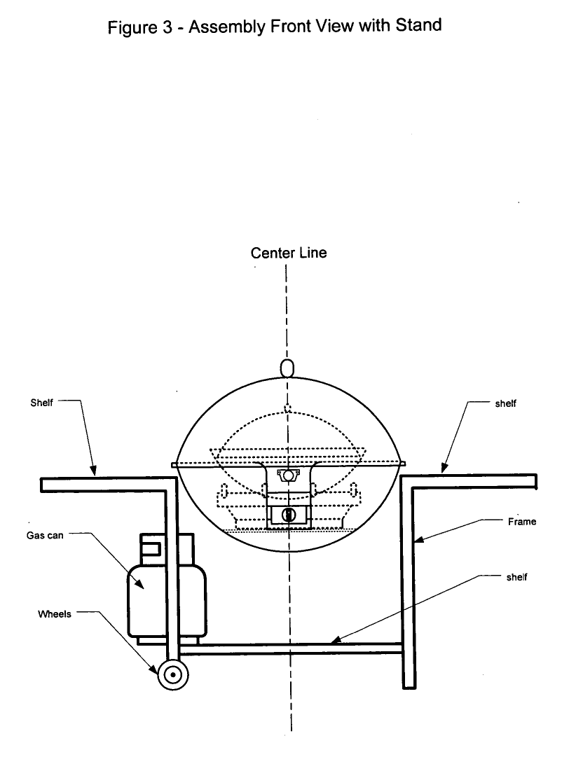

Household outdoor gas cooking stove with an enclosure to provide wind shielding during cooking and protect stove and cooking apparatus while not in use

### BACKGROUND OF TH INVENTION

This invention is to use the outdoor barbeque grill like shell as an enclosure for a gas stove and cooking apparatus such as a wok and a frying pan. Cooking methods such as stir-fry, pan-fry and deep-fry are likely to generate large amount of oily steam, smoke, and strong smells that is sometimes not desired inside of an average American home. The cooking odor from food groups such as seafood and other gamy or strong smell foods are also not desired. Applying the aforementioned types of cooking methods and cooking of these food groups outdoors would be much more desired. In order to improve the outdoor cooking experience, an enclosure to block the wind during cooking is essential as wind may decreased or extinguish the cooking flame with ordinary outdoor gas stove. The enclosure also includes a lid that can protect the cooking stove and wok or pan from rain, wind, snow and other natural elements while the unit is not in use. Average American homes do not have powerful enough range hood to evacuate the oily steam, smoke, and odor out of the house efficiently therefore outdoor cooking appliance as described can be well received. This cooking appliance also equipped with wheels for maneuverability and shelves to accommodate plates and food items.

### SUMMARY OF THE INVENTION

This invention is to utilize the barbeque grill like enclosure of all shapes housing over a powerful gas stove and wok or pan. This unit is for household daily use that can fulfill the desire of cooking enthusiasts. The enclosure protects the flame from wind during cooking so it can remain near constant power output of the gas stove. The enclosure's upper lid can protect the stove and wok or pan from rain, wind, snow and other natural elements when the unit is not in use. The holes in the bottom of the enclosure can act as additional air intake holes for the gas stove and provide drainage for liquids. The stove is more powerful than the indoor range stoves to achieve the high heat that is desired for stir fry or other cooking methods. These advantages along with wheels and shelves make this unit an all-around outdoor cooking station.

1. What I claim as my invention is the use of barbeque grill like enclosure of all shapes to cover the outdoor stove and cooking apparatus.

2. What I claim as my invention is to use a gas stove inside of the barbeque grill like enclosure.

3. What I claim as my invention is the use of a more powerful gas stove than the ordinary indoor gas range; the power output is greater than 16,000 BTU/hour.

4. What I claim as my invention is the use of the barbeque grill like frame, shelves, and wheels with my stove and enclosure.

5. What I claim as my invention is the use of holes in the bottom part of the enclosure for air intake and drainage.

6. What I claim as my invention is the cut-out of the lower part of the enclosure for easy reaching of the gas stove igniter and let the handle of the wok or pan to protrude.
